(19) United States
(12) Patent Application Publication
(10) Pub. No.: US 2015/0162713 A1
(43) Pub. Date: Jun. 11, 2015

(54) ELECTRICAL CONNECTOR

(71) Applicant: FOXCONN INTERCONNECT TECHNOLOGY LIMITED, Grand Cayman (KY)

(72) Inventors: KUEI-CHUNG TSAI, New Taipei (TW); JIAN-JIA QI, Kunshan (CN)

(21) Appl. No.: 14/566,605

(22) Filed: Dec. 10, 2014

(30) Foreign Application Priority Data
Dec. 10, 2013 (CN) 201310663099.9

(51) Int. Cl. H01R 24/60

(52) U.S. Cl. CPC H01R 24/60

(57) ABSTRACT

An electrical connector includes an insulative housing (10), a number of upper terminals (20) and a number of lower terminals (30) received in the insulative housing. The upper terminals comprise a pair of signal terminals (21) and a ground terminal (22) on one side of the pair of the pair of signal terminals; and an insulative body insert molded with the upper terminals to constitute a terminal module. The upper terminal has a fixed portion (201) and an elastic arm (301). Both the fixed portions of the signal terminal and the ground terminal have a same first width (201a). Both the elastic arms of the signal terminal and the ground terminal have a same second width (202a). The second width is wider than the first width. Every two adjacent fixed portions of the upper terminals are equidistant, and every two adjacent elastic arms of the upper terminals are equidistant.

### BACKGROUND OF THE INVENTION

1. Field of the Invention

The present invention relates to an electrical connector and especially relates to differentially coupled terminals of the electrical connector.

2. Description of Related Art

U.S. Publication No. 2013/0196550 discloses a differentially coupled electrical connector including an insulative housing, a number of upper terminals, and a number of lower terminals. The upper terminals are insert molded in a terminal block. The terminal block supports the upper terminals and is mounted to the housing. The upper terminals include a pair of signal terminals and a respective ground terminal on one of two sides of the pair of signal terminals. The upper terminal includes a tail, a contact, and a body. The body of the terminal includes a block portion and a free portion. By using preferential differential coupling, it is possible to decrease the insertion loss to about 0.1 dB dip and to move the frequency of this dip loss out to frequencies greater than 11 GHz, compared to an exemplary connector with a 0.5 dB dip in insertion loss at about 8 GHz.

In the above prior art design, terminals having a different structure are required to achieve a better performance at high frequencies.

An electrical connector having a good performance at high frequency is desired.

### SUMMARY OF THE INVENTION

Accordingly, an object of the present invention is to provide an electrical connector requiring a number of terminals with specific structure while achieving a good performance of high frequency.

In order to achieve the object set forth, the invention provides an electrical connector comprising: an insulative housing defining a front mating face, an upper wall, a lower wall, and a receiving space between the upper wall and the lower wall, the upper wall defining a plurality of first terminal slots, the lower wall defining a plurality of second terminal slots; a plurality of upper terminals and a plurality of lower terminals received in the insulative housing, the upper terminals comprising a pair of signal terminals and a ground terminal on one side of the pair of the pair of signal terminals; and an insulative body insert molded with the upper terminals to constitute a terminal module, the upper terminal having a fixed portion insert molded in the insulative body and an elastic arm extending beyond the insulative body and received in the first terminal slot; wherein both the fixed portions of the signal terminal and the ground terminal have a same first width, both the elastic arms of the signal terminal and the ground terminal have a same second width, the second width is wider than the first width, every two adjacent fixed portions of the upper terminals are equidistant, and every two adjacent elastic arms of the upper terminals are equidistant.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of an electrical connector according to the present invention;

FIG. 2 is another perspective view of an electrical connector as shown in FIG. 1;

FIG. 3 is an explosive view of the electrical connector according to the present invention;

FIG. 4 is another explosive view of the electrical connector as shown in FIG. 3;

FIG. 5 is a perspective view of the upper terminals of the electrical connector according to the present invention;

FIG. 6 is a rear view of the upper terminals of the electrical connector according to the present invention; and

FIG. 7 is a perspective view of the terminal module of the electrical connector according to the present invention.

### DETAILED DESCRIPTION OF THE PREFERRED EMBODIMENT

Reference will now be made in detail to the preferred embodiment of the present invention.

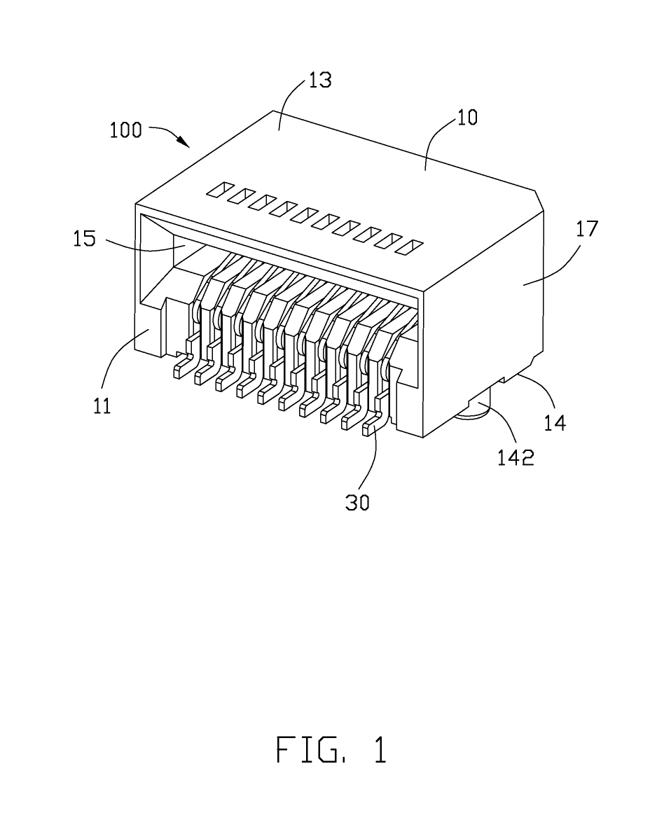

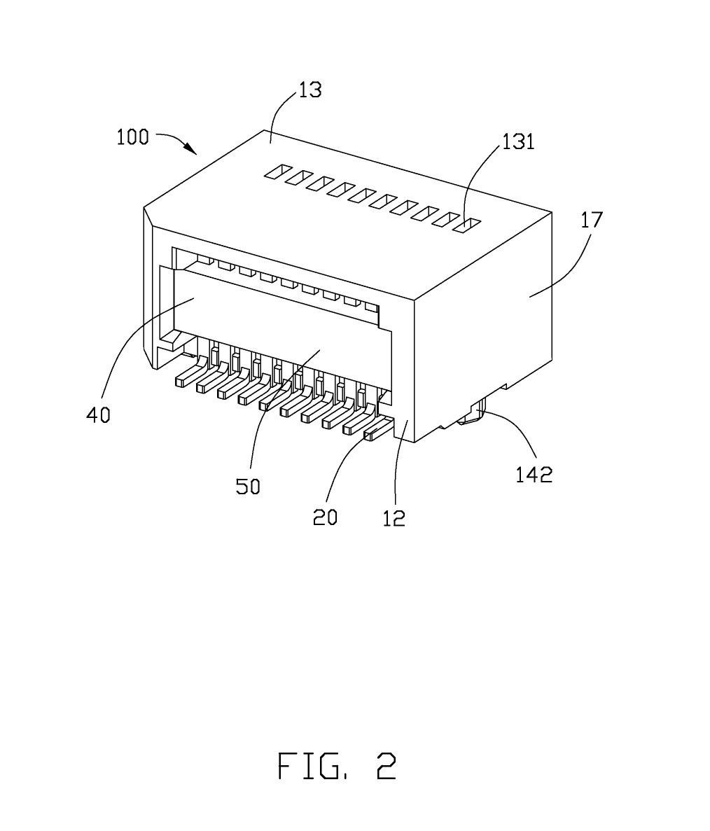

Referring to FIGS. 1 and 2, an SFP (Small Form-factor Pluggable) electrical connector 100 includes an insulative housing 10, a row of upper terminals 20, a row of lower terminals 30, and an insulative body or insulator 40. The row of upper terminals 20 are insert molded in the insulative body 40 and constitute a terminal module 50.

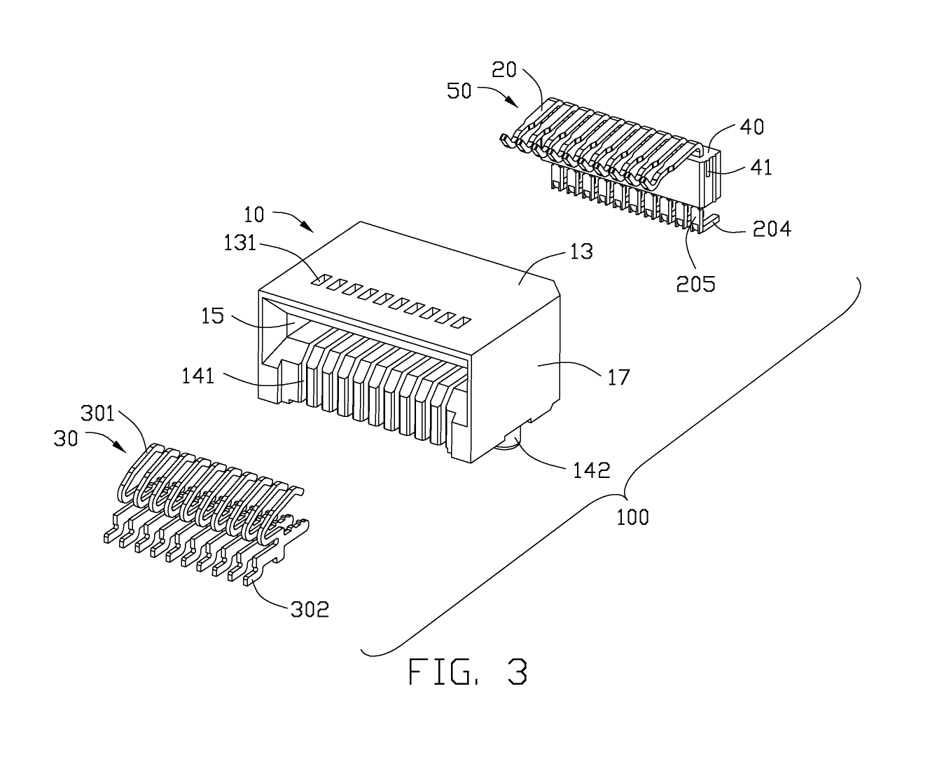

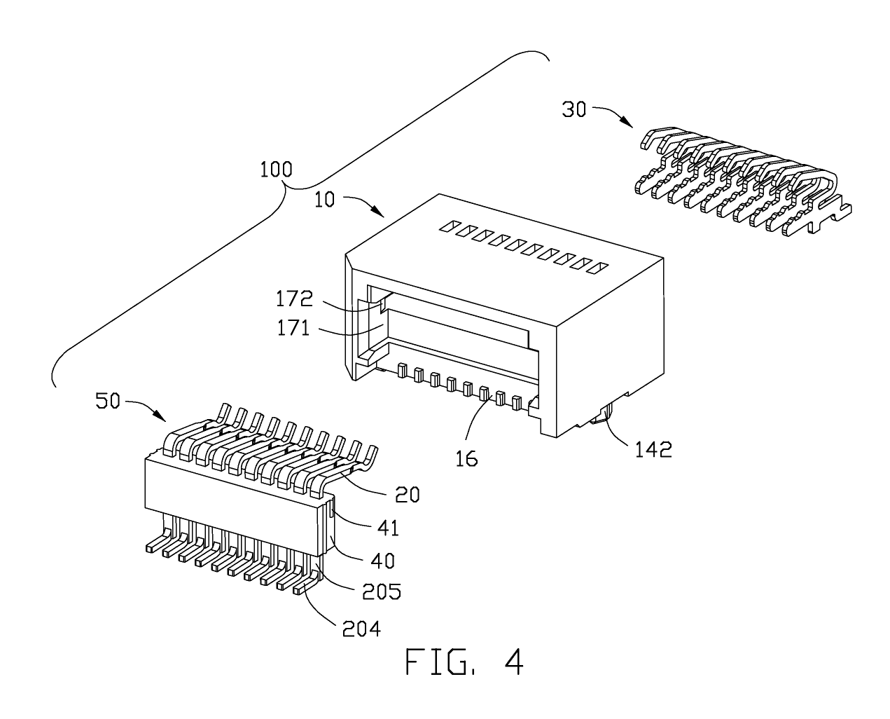

Referring to FIGS. 3 and 4, the insulative housing 10 includes a mating face 11, a rear face 12, an upper wall 13, a lower wall 14, and a receiving space 15 between the upper wall 13 and the lower wall 14. Both of the upper wall 13 and the lower wall 14 backwardly extend from the mating face 11. The upper wall 13 defines a number of first terminal slots 131. The lower wall 14 defines a number of second terminal slots 141. The terminal module 50 as a whole is mounted into the first terminal slots 131 from the rear face 12 along a back-to-front direction. The lower terminals 30 are mounted into the second terminal slots 141 from a mating face 11 along a front-to-back direction. The lower terminal 30 has a second elastic arm 301 forwardly extending into the second terminal slots 141 and an engaging section 302 extending beyond the mating face 11.

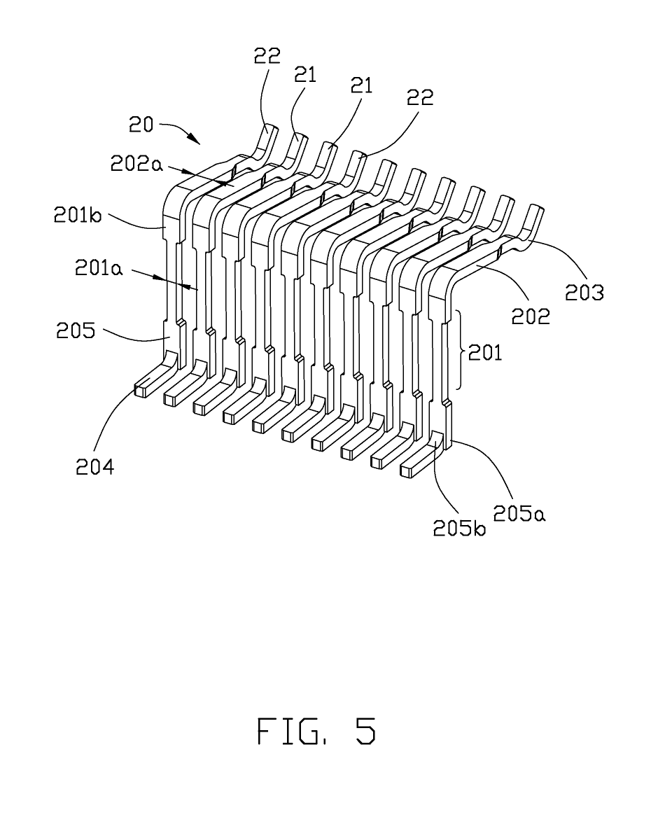

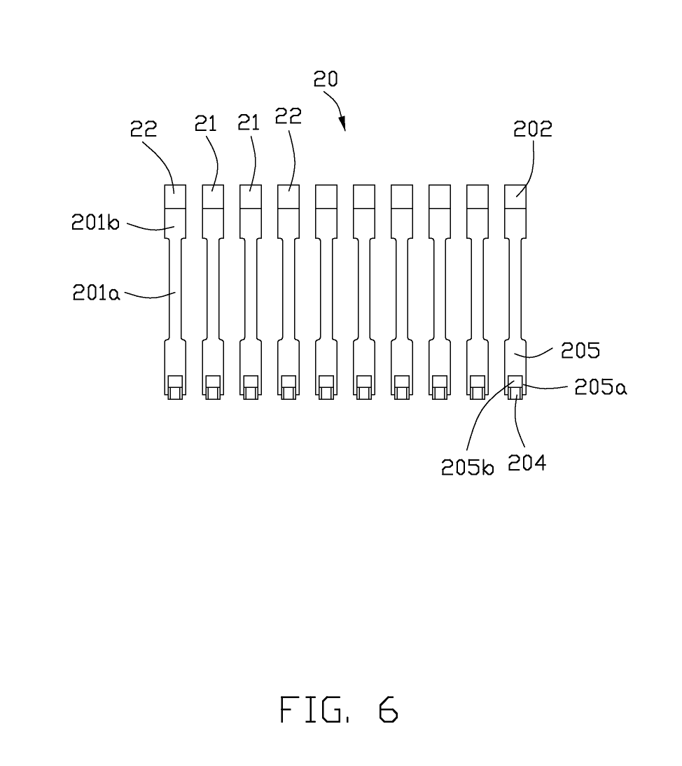

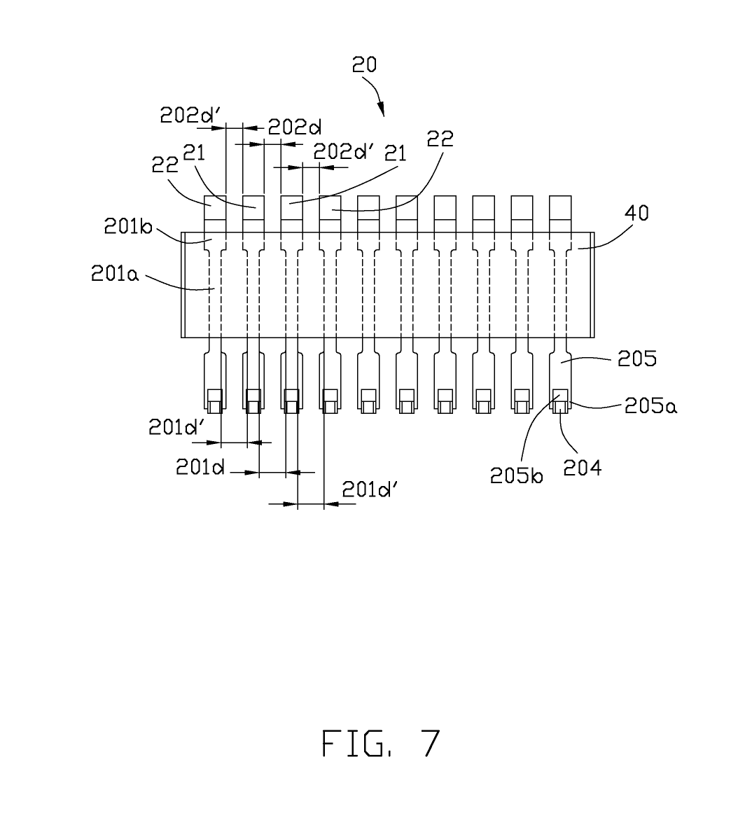

Referring to FIGS. 5-7, the upper terminal 20 has a fixed portion 201 fixed in the insulative body 40, an elastic arm 202 extending from the fixed portion 201 beyond the insulative body 40, and a contact portion 203 extending from the elastic arm 202. The elastic arm 202 is received in the first terminal slot 131. The contact portion 203 is received in the receiving space 15. The upper terminal 20 includes a pair of signal terminals 21 for differential signal transmission and a respective ground terminal 22 on two sides of the pair of signal terminals 21. The structure of the signal terminal 21 is same as the structure of the ground terminal 22.

Both the fixed portions 201 of the signal terminal 21 and the ground terminal 22 have a same first width 201a. Both the elastic arms 202 of the signal terminal 21 and the ground terminal 22 have a same second width 202a. The second width 202a is wider than the first width 201a. Each first distance 201d which is between two adjacent fixed portions 201 of the signal terminal 21 is same. Each second distance 201d′ which is between a fixed portion 201 of a ground terminal 22 and another fixed portion 201 of a signal terminal 21 adjacent to aforesaid ground terminal 22 is same. Each third distance 202d which is between two adjacent elastic arms 202 of the signal terminal 21 is same. Each fourth distance 202d′ which is between an elastic arm 202 of a ground terminal 22 and another elastic arm 202 of a signal terminal 21 adjacent to aforesaid ground terminal 22 is same.

The fixed portion 201 includes a widened portion 201b connecting with the elastic arm 202. The width of the widened portion 201b is wider than the first width 201a. The width of the contact portion 203 is small than the width of the elastic arm 202. The contact portion 203 electrically connects with mating connector entering into the receiving space 15. The fixed portion 201 extends in a vertical direction. The upper terminal 20 further includes a soldering portion 204 and a positioning portion 205 connecting the fixed portion 201 and the soldering portion 204. The soldering portion 204 backwardly extends in a horizontal direction. The positioning portion 205 includes a bending portion 205a and two torn edges 205b. Each of the torn edges 205b is in one side of the bending portion 205a. A slit is between the torn edge 205b and the bending portion 205a.

Referring to FIGS. 3 and 4, the rear face 12 of the insulative housing 10 defined a number of tabs, the middle of adjacent two tabs forming a groove 18. The positioning portion 205 is received in the groove 18. The insulative housing 10 further includes two side walls 17 connecting with the upper wall 13 and the lower wall 14. The side wall 17 defines a guide slot 171. The terminal module 50 is mounted along a back-to-front direction in the guide slot 171. The insulative body 40 is received in the guide slot 171. The side wall 17 has a recess 172 in the guide slot 171, the insulative body 40 having a flange 41. When the insulative body 40 is received in the guide slot 171, the flange 41 is held in the recess 172. The electrical connector 100 further includes a mounting post 142 on the lower wall 14 for mounting on the outer component.

The structure of the upper terminals 20 are so designed that insertion loss of the electrical connector 100 will be reduced. The electrical connector 100 provides less than −1 dB of insertion loss when used as a different signal pair at a signaling frequency of 17 GHz. The electrical connector 100 provides greater than −10 dB of return loss when used as a different signal pair at a signaling frequency of 17 GHz.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the members in which the appended claims are expressed.

What is claimed is:

1. An electrical connector comprising:
an insulative housing defining a front mating face, an upper wall, a lower wall, and a receiving space between the upper wall and the lower wall, the upper wall defining a plurality of first terminal slots, the lower wall defining a plurality of second terminal slots;
a plurality of upper terminals and a plurality of lower terminals received in the insulative housing, the upper terminals comprising a pair of signal terminals and a ground terminal on one side of the pair of the pair of signal terminals; and
an insulative body insert molded with the upper terminals to constitute a terminal module, the upper terminal having a fixed portion insert molded in the insulative body and an elastic arm extending beyond the insulative body and received in the first terminal slot;
wherein both the fixed portions of the signal terminal and the ground terminal have a same first width, both the elastic arms of the signal terminal and the ground terminal have a same second width, the second width is wider than the first width, every two adjacent fixed portions of the upper terminals are equidistant, and every two adjacent elastic arms of the upper terminals are equidistant.

2. The electrical connector as claimed in claim 1, wherein the fixed portion comprises a widened portion connecting with the elastic arm, the width of the widened portion being wider than the first width.

3. The electrical connector as claimed in claim 1, wherein the upper terminal comprises a contact portion extending into the receiving space for connecting with a mating connector, the width of the contact portion being smaller than the width of the elastic arm.

4. The electrical connector as claimed in claim 1, wherein the fixed portion extends in a vertical direction, and the upper terminal comprises a soldering portion backwardly extending in a horizontal direction.

5. The electrical connector as claimed in claim 4, wherein the upper terminal comprises a positioning portion between the fixed portion and the soldering portion, the positioning portion comprising a bending portion and a torn edge beside the bending portion.

6. The electrical connector as claimed in claim 5, wherein the insulative housing comprises a rear face having a plurality of tabs, a middle of adjacent two tabs forming a groove, the positioning portion received in the groove.

7. The electrical connector as claimed in claim 1, wherein the insulative housing comprises two side walls connecting with the upper wall and the lower wall, the side wall has a guide slot, and the terminal module is mounted along a back-to-front direction in the guide slot.

8. The electrical connector as claimed in claim 7, wherein the side wall has a recess in the guide slot, and the insulative body has a flange clamped into the recess.

9. The electrical connector as claimed in claim 1, wherein the pair of signal terminals provides less than −1 dB of insertion loss when used as a different pair at a signaling frequency of 17 GHz.

10. An electrical connector comprising:
an insulative housing including opposite upper and lower walls opposite to each other with a receiving space therebetween in a vertical direction;
a plurality of upper terminals disposed in the housing with upper contacting portions exposed around the upper wall;
a plurality of lower terminal disposed in the housing with lower contacting portions exposed around the lower wall;
each of said upper terminals including an elastic arm linked to and located behind the corresponding contacting portion and extending along an interior surface of the upper wall in a front-to-back direction perpendicular to said vertical direction, a fixed portion linked to a rear end of the elastic arm and extending downwardly, and a solder portion located below the fixed portion in the vertical direction; and
at least a section of the fixed portion of said upper terminal being integrally formed with and embedded within an insulator so as to have the insulator with all said upper terminals be a terminal module, wherein
in each upper terminal, a width of the elastic arm is larger than that of the section of the fixed portion in a transverse direction perpendicular to both said vertical direction and said front-to-back direction for impedance adjustment while in the terminal module, a pitch among the elastic arms is same with that among the fixed portions.

11. The electrical connector as claimed in claim 10, wherein the contacting portion is narrower than the fixed portion in said transverse direction.

12. The electrical connector as claimed in claim 10, wherein the solder portion is narrower than the elastic arm in said transverse direction.

13. The electrical connector as claimed in claim 10, wherein a width of each of said lower terminals is not larger than that of the contacting portion of each of the upper terminals in the transverse direction.

14. The electrical connector as claimed in claim 10, wherein in each of the upper terminals, the contacting portion is curved while both the fixed portion and elastic arm are straight.

15. An electrical connector comprising:
an insulative housing including opposite upper and lower walls opposite to each other with a receiving space therebetween in a vertical direction;
a plurality of upper terminals disposed in the housing with upper contacting portions exposed around the upper wall;
a plurality of lower terminal disposed in the housing with lower contacting portions exposed around the lower wall;
each of said upper terminals including an elastic arm linked to and located behind the corresponding contacting portion and extending along an interior surface of the upper wall in a front-to-back direction perpendicular to said vertical direction, a fixed portion linked to a rear end of the elastic arm and extending downwardly, and a solder portion located below the fixed portion in the vertical direction; and
at least a section of the fixed portion of said upper terminal being integrally formed with and embedded within an insulator so as to have the insulator with all said upper terminals be a terminal module, wherein
each of the lower terminals is stamped from sheet metal with a thickness direction parallel to a transverse direction perpendicular to both said front-to-back direction and said vertical direction while each of the upper terminal is stamped from sheet metal with a thickness direction perpendicular to said transverse direction.

16. The electrical connector as claimed in claim 15, wherein a width of the upper terminal in the transverse direction is larger than that of the lower terminal.

17. The electrical connector as claimed in claim 15, wherein each of the lower terminals includes a retention post, and the lower terminals are retained to the housing via said retention posts rearwardly inserted into the housing in the front-to-back direction, respectively, while the upper terminals are forwardly assembled to the housing via the insulator commonly in the front-to-back direction.

18. The electrical connector as claimed in claim 15, wherein in each of said upper terminals, the elastic arm is wider than both the contacting portion and said section of the fixed portion in the transverse direction.
